(19) United States
(12) Patent Application Publication
(10) Pub. No.: US 2017/0270092 A1
(43) Pub. Date: Sep. 21, 2017

(54) SYSTEM AND METHOD FOR PREDICTIVE TEXT ENTRY USING N-GRAM LANGUAGE MODEL

(71) Applicants: Nuance Communications, Inc., Burlington, MA (US); NUANCE SOFTWARE AND TECHNOLOGY (BEIJING) CO, LTD, Beijin (CN)

(72) Inventors: Nan He, Beijing (CN); Jianchao Wu, Bellevue, WA (US)

(21) Appl. No.: 15/529,588

(22) PCT Filed: Nov. 25, 2014
(86) PCT No.: PCT/CN2014/092124

§ 371 Date: May 25, 2017

(51) Int. Cl. G06F 17/27; G06F 3/023; G06F 3/0482

(52) U.S. Cl. CPC G06F 17/276; G06F 17/2785; G06F 3/0482; G06F 3/0237

(57) ABSTRACT

The disclosed system provides an improved method for text input by using linguistic models based on conditional probabilities to provide meaningful word completion suggestions based on previously entered words. The system uses previously entered n-grams, where n>=2, to generate a list of candidate words matching a current user input. The candidate words are based on one or more conditional probabilities, where the conditional probabilities show a probability of a candidate word following a previously entered n-gram. The system displays the list of candidate words to the user and allows the user to select a desired word for entry. The system also utilizes the context of the text entry to select the candidate words.

### BACKGROUND

Text based communication using mobile devices is increasing. Every day millions of people send text messages and email and even perform traditional document authoring using their mobile devices. As the demand for mobile device text entry increases, mobile device developers face significant challenges providing reliable and efficient text entry.

Therefore, to increase the rate of text input, predictive text entry systems have developed. Although constantly improving in accuracy and ease of use, there still exists a need for a text entry system that allows fast, accurate text entry, while lowering the cognitive load imposed on users to sift through unwanted word suggestions.

Overall, the examples herein of some conventional or related systems and their associated limitations are intended to be illustrative and not exclusive. Other limitations of existing or conventional systems will become apparent to those of skill in the art upon reading the following Detailed Description.

### BRIEF DESCRIPTIONS OF THE DRAWINGS

FIG. 1 is a block diagram illustrating an operating environment for the disclosed technology.

FIG. 2 is a flow diagram illustrating a method for building a language model.

FIG. 3 is a flow diagram illustrating a method for entering text in an input field.

FIG. 4 is a diagram illustrating text input and output according to the method of FIG. 3.

FIG. 5 is a block diagram illustrating a data structure containing conditional probabilities given a prior n-gram.

FIG. 6 is a block diagram illustrating a system for entering text in an input field.

### DETAILED DESCRIPTION

The disclosed technology provides an improved method for text input by using linguistic models based on conditional probabilities to provide meaningful word completion suggestions based on previously entered words. The disclosed technology eliminates much of the frustration experienced by users of conventional systems and increases text entry speeds while reducing the cognitive load required to use conventional systems.

A system and method are described in detail below that employs previously entered text or “prior n-gram” input (where n≧2) to modify a list of candidate words matching a current user input. For example, a method for implementing the disclosed technology may include receiving a prior n-gram as a result of a user's input of text. As discussed below, and for languages written from left to right, the prior n-gram may include two or more previously entered words followed by a space, punctuation (e.g. a hyphen), or another word. Of course, aspects of the invention apply equally to languages written from right to left, top to bottom, etc., and the term “prior n-gram” is equally applicable to all such languages. Nevertheless, for clarity and conciseness reasons, the left-to-right language of English will be used as an example throughout.

The system and method may also receive a user input corresponding to a part of a word or an entire word. The system retrieves a set of one or more candidate words that match the user input based on one or more conditional probabilities, where the conditional probabilities show a probability of a candidate list given a particular prior n-gram. The system displays the modified list of candidate words to the user. The system then receives a selection by the user of one of the words from the list of candidate words. The system then utilizes the selected word as the desired text entered by the user.

By presenting a list based on conditional probabilities, the system and method may reduce the cognitive load on the user. The user's intended word may be consistently closer to the top of the suggested words list or may be determined based on fewer entered characters as compared to other text entry systems. Particularly in languages such as German where the average number of characters per word is relatively high or Chinese where there are a large number of characters in the language, a system that can accurately predict an intended word using fewer letters may significantly reduce the user's cognitive load.

For example, as a user enters the letters “ea” a list of matching candidate words may contain the words “ear” and “earth.” If the previous words entered by the user are “I am on the planet” the suggestion “earth” may be moved above the closest match “ear” because the contextual probability suggests that “earth” is more likely the next word. In a further example, again the user may have entered the letters “ea,” and “The distance from Mars to the” are the previous words entered by the user. In this example, the word “earth” is again more likely than “ear.” However, in this context, the system may determine that, given the use of a capitalized celestial body in the previous five words, “earth” should be capitalized. The system would then suggest “Earth” before “ear” in a list of candidate words. In an implementation, based on the n-gram “I am on the planet,” the suggestion “earth” can be listed before the user enters “ea.” Alternatively, if the user enters an ambiguous entry, due to misspelling or nature of the entry (e.g., 12 key pad), the suggestion “earth” can be resolved based on the n-gram.

Overall, variables such as (A), (B), and (X) as used herein indicate one or more of the features identified without constraining sequence, amount, or duration other than as further defined in this application. Without limiting the scope of this detailed description, examples of systems, apparatus, methods, and their related results according to the embodiments of the present disclosure are given below. Unless otherwise defined, all technical and scientific terms used herein have the same meaning as commonly understood by one of ordinary skill in the art to which this disclosure pertains. In the case of conflict, the present document, including definitions, will control. The terms used in this detailed description generally have their ordinary meanings in the art, within the context of the disclosure, and in the specific context where each term is used. For convenience, certain terms may be emphasized, for example using italics and/or quotation marks. The use of emphasis has no influence on the scope and meaning of a term; the scope and meaning of a term is the same, in the same context, whether or not it is emphasized. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

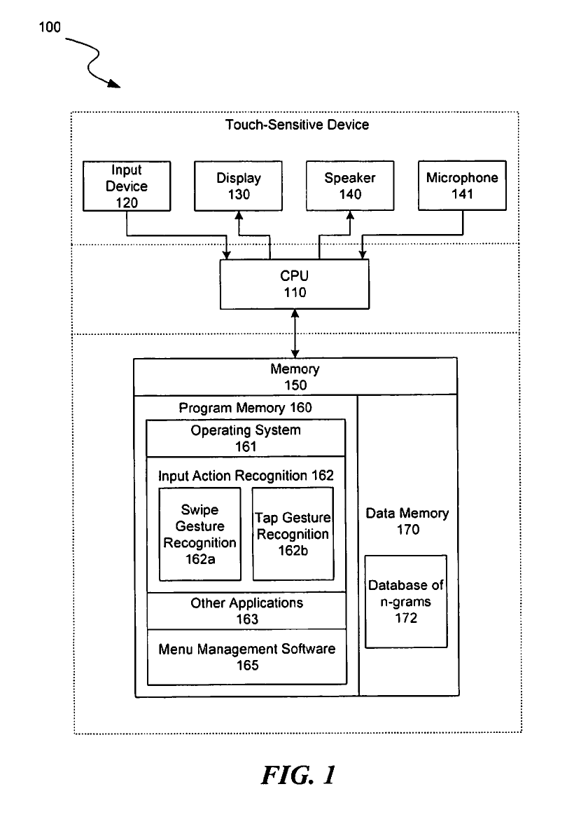

FIG. 1 is a block diagram illustrating an operating environment for the disclosed technology. The operating environment comprises hardware components of a device 100 for implementing a statistical language model text input system. The device 100 includes one or more input devices 120 that provide input to the CPU (processor) 110, notifying it of actions performed by a user, such as a tap or gesture. The actions are typically mediated by a hardware controller that interprets the signals received from the input device and communicates the information to the CPU 110 using a known communication protocol. Input devices 120 include, for example, a capacitive touchscreen, a resistive touchscreen, a surface wave touchscreen, a surface capacitance touchscreen, a projected touchscreen, a mutual capacitance touchscreen, a self-capacitance sensor, an infrared touchscreen, an infrared acrylic projection touchscreen, an optical imaging touchscreen, a touchpad that uses capacitive sensing or conductance sensing, or the like. Other input devices that may employ the present system include wearable input devices with accelerometers (e.g. wearable glove-type input devices), a camera- or image-based input device to receive images of manual user input gestures, and so forth.

The CPU may be a single processing unit or multiple processing units in a device or distributed across multiple devices. Similarly, the CPU 110 communicates with a hardware controller for a display 130 on which text and graphics, such as support lines and an anchor point, are displayed. One example of a display 130 is a display of the touchscreen that provides graphical and textual visual feedback to a user. In some implementations, the display includes the input device as part of the display, such as when the input device is a touchscreen. In some implementations, the display is separate from the input device. For example, a touchpad (or trackpad) may be used as the input device 120, and a separate or standalone display device that is distinct from the input device 120 may be used as the display 130. Examples of standalone display devices are: an LCD display screen, an LED display screen, a projected display (such as a heads-up display device), and so on. Optionally, a speaker 140 is also coupled to the processor so that any appropriate auditory signals can be passed on to the user. For example, device 100 may generate audio corresponding to a selected word. In some implementations, device 100 includes a microphone 141 that is also coupled to the processor so that spoken input can be received from the user.

The processor 110 has access to a memory 150, which may include a combination of temporary and/or permanent storage, and both read-only and writable memory (random access memory or RAM), read-only memory (ROM), writable non-volatile memory, such as flash memory, hard drives, floppy disks, and so forth. The memory 150 includes program memory 160 that contains all programs and software, such as an operating system 161, input action recognition software 162, and any other application programs 163. The input action recognition software 162 may include input gesture recognition components, such as a swipe gesture recognition portion 162a and a tap gesture recognition portion 162b, though other input components are of course possible. The input action recognition software may include data related to one or more enabled character sets, including character templates (for one or more languages), and software for matching received input with character templates and for performing other functions as described herein. The program memory 160 may also contain menu management software 165 for graphically displaying two or more choices to a user and determining a selection by a user of one of said graphically displayed choices according to the disclosed method. The memory 150 also includes data memory 170 that includes any configuration data, settings, user options and preferences that may be needed by the program memory 160, or any element of the device 100. In some implementations, the memory also includes dynamic template databases to which user/application runtime can add customized templates. The runtime-created dynamic databases can be stored in persistent storage and loaded at a later time.

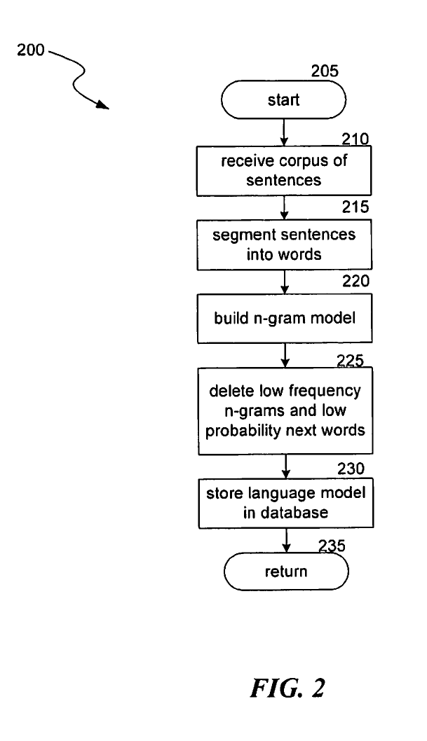

In an implementation, the data memory 170 includes a language model database 172 comprising n-grams and associated next word probabilities. The database 172 can include bi-grams, or pairs of words (if n=2) with corresponding probabilities for third words (e.g., the bi-gram “The planet” may be associated with single words and probabilities like Earth 60%; Mars 30%; Mercury 5%; etc.) and/or three word combinations in order of probability (e.g., The planet Earth 60%; The planet Mars 30%). Alternatively, longer n-grams can be used (e.g., tri-grams, etc.). In an implementation, the database 172 can be stored in a second memory (not shown) communicatively coupled to the device 100. The second memory can be accessed from a remote device (e.g., server) via function or service calls, or can be physically coupled to the device 100. If the database 172 is stored locally, it may only include n-grams having a high frequency of occurrence and next words having a high probability (e.g., next words having a probability that exceeds ≧25%). Further, the database 172 can be periodically updated with updated words and probabilities from a remote device based on news events (e.g., a discovery on Mercury could temporarily raise the probability of Mercury to greater than Mars), changes in the language (e.g., as new words enter the lexicon), and/or other reasons. The database 172 can also be updated based on user preferences and/or usage as will be discussed further below. The database 172 will also be discussed in further detail below in conjunction with FIG. 2.

In some implementations, the device 100 also includes a communication module capable of communicating wirelessly with a base station or access point using a wireless mobile telephone standard, such as the Global System for Mobile Communications (GSM), Long Term Evolution (LTE), IEEE 802.11 (e.g., WiFi), or another wireless standard. The communication device may also communicate with another device or a server through a network using, for example, TCP/IP protocols. For example, device 100 may utilize the communication device to offload some processing operations to a more robust system or computer. In other implementations, once the necessary database entries or dictionaries are stored on device 100, device 100 may perform all the functions required to perform context based text entry without reliance on any other computing devices.

Device 100 may include a variety of computer-readable media, e.g., a magnetic storage device, flash drive, RAM, ROM, tape drive, disk, CD, or DVD. Computer-readable media can be any available storage media and include both volatile and nonvolatile media and removable and non-removable media.

In an implementation, the device 100 also includes a location determining system, which determines the location of the device 100 using global positioning system (GPS) signals and/or or other methods. The location determining system can be communicatively coupled to the CPU 110.

The disclosed technology is operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

It is to be understood that the logic illustrated in each of the following block diagrams and flow diagrams may be altered in a variety of ways. For example, the order of the logic may be rearranged, sub-steps may be performed in parallel, illustrated logic may be omitted, other logic may be included, etc.

FIG. 2 is a flow diagram illustrating a method 200 implemented by the system for building the language model. The method begins at block 205 and continues to block 210. At block 210, the system receives a corpus of sentences in the language for which the model is being built. For example, for a Chinese implementation, a corpus of Chinese sentences. Next, at block 215, the system segments the sentences into words (including segmentation of multi-character words in a Chinese implementation or other non-space delineated ideographic languages, e.g., -↑ [symbol] —4 characters into two words: one apple). A language model is then built based on frequency of the combinations. That is, the model represents for certain ordered combinations of n words (e.g., two words, three words), the probability of a specific next word following those n words. N-grams having a low frequency of occurrence (e.g., two word phrases that rarely occur) or next words having a low probability of following the corresponding n-gram (e.g., next words that occur less than 25% of the time) are then optionally deleted in block 225 to conserve memory and reduce processing. Alternatively, at block 220, low frequency n-grams and low probability next words are not including during the building process. The resulting language model is then stored in block 230 and the method returns at block 235. The storing, in block 230, can be at a remote device and/or in the data memory 170. Alternatively, the storing can first be in the remote device and then transmitted to the data memory 170. Updates, including new language models (for languages other than the initial language) or revised language models based on changes to a language over time can also be stored at block 230 when generated. Although the system primarily relies on bi-grams when constructing the language model, it will be appreciated that the method disclosed herein extends equally to other constructions where n>=3.

As a user selects next words in method 300, as described further below, the system can modify the language model to change the probabilities to better reflect the particular language use of the user. If the user consistently selects one of the next word predictions following a particular n-gram, the probability of that next word can be increased for that n-gram so that it is subsequently promoted higher in the displayed list. Similarly, if the user consistently ignores one of the next word predictions following a particular n-gram, the probability of the next word for that n-gram can be decreased so that it is demoted lower in a subsequently displayed list. If the decrease causes the probability of the next word to fall below a predetermined probability (e.g., 25%), the next word may be removed from the language model.

In some embodiments, different language models can be generated for different contexts. For example, a shopping language model can be generated for when a device using the language model is inside of a shopping mall (e.g., based on a comparison of GPS coordinates to the latitude/longitude coordinates of the shopping mall). Alternatively, a business language model can be generated for when a user is using a work email application on the device vs. a general purpose language model that can be generated for when the user is using a social media application. In some embodiments, the language models can be combined with n-grams having multiple next words probabilistically ranked based on context. The next word prediction is then assessed based on the context of the user at the time of text entry.

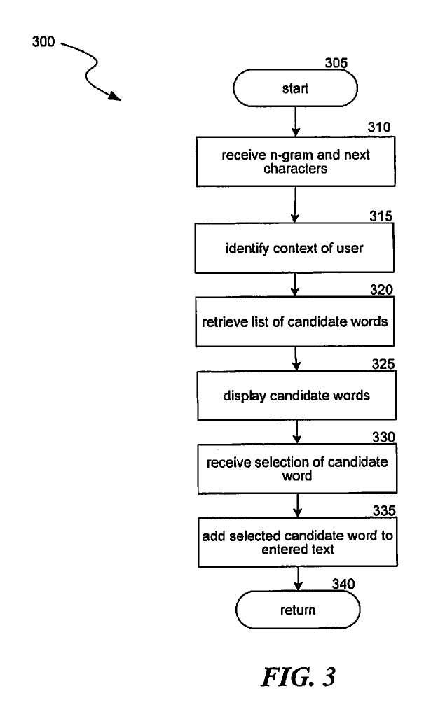

FIG. 3 is a flow diagram illustrating a method 300 implemented by the system for facilitating text entry by a user. The method begins at block 305 and continues to block 310. At block 310 the system receives text entry representing a prior n-gram and one or more characters representing a full or partial next word. As used herein, “prior n-gram” or merely “n-gram” refers to a set of two or more words preceding the current user input (or two characters representing a word or word-portion in a character-based language such as Chinese). Of course, aspects of the invention apply equally to languages written from left to right, right to left, top to bottom, etc., and the term “prior n-gram” is equally applicable to all such languages. Nevertheless, for clarity and conciseness reasons, the left-to-right language of English will be used as an example herein.

At block 315, in some embodiments the system selects a language model based on the context of the user. For example, if the user is in a text messaging application, the language model that is applied may be different than a language model applied when the user is editing a document in Word. As another example, if a mobile device GPS shows that a user is at a shopping mall, terms associated with shopping may be proposed higher in the candidate list. In some embodiments, only a common language model is applied across all text entry by the user.

At block 320, the system utilizes the language model to retrieve a list of candidate words based on the received n-gram. The list of candidate words is narrowed by the system depending on the received character or characters corresponding to a part of a word or whole word entered by the user following the n-gram (referred to as “user input (A)”). The user input (A) may be received via, for example, a push-button keyboard, a virtual keyboard, a finger or stylus interacting with a touchscreen, real or virtual buttons on a remote, or input buttons on a device such as a game controller, mobile phone, mp3 player, computing pad, or other device. The user input (A) may be separated from the prior n-gram received in block 310 by a space, hyphen, comma, other delineating symbol, etc. The user input (A) may be a series of key taps, one or more gestures or swipes, motions on a joystick, a spoken command, a visual motion captured by a camera, or any other input from a user indicating one or more letters. The system resolves the user input (A) into the portion of the word comprising one or more letters or characters. In some embodiments, the portion of the word may comprise sets of characters. For example, the user input (A) may comprise a series of key presses, where each key press corresponds to a set of characters.

The candidate words may be selected from a local database 172, retrieved from a server, stored in a data structure in memory, or received from any other data source available to the device executing the method. The candidate words are based on the likelihood of following the received prior n-gram as discussed above. That is, next words having the highest probability of following the previously-entered n-gram are selected for display before words having a lower probability of following the previously-entered n-gram. Additional candidate words can be selected based on conventional methods or when no n-grams exist in a memory (e.g., when there are no relevant n-grams in the database 172).

At block 325 the system displays one or more of the identified candidate words. In various embodiments the list of candidate words may be displayed in a selection menu integrated with a virtual input keyboard, in a text input field, or at a location defined by the start or end of the user input (A). The list of candidate words may be displayed with various formatting indications of modifications. The most probable word may be in a different color or style, or words from a particular language model may be in a first color or style while words from another language mode may be in a different color or style. For example, if the user has two language models enabled for different languages, the words from the user's native language may show up in green while the words from a second language may show up in blue. Additionally, candidate words that include a change to the user input (A) may be shown in a different format. For example, if the modification to the list of candidates resulted in a capitalization of a letter indicated in the user input (A), the capitalized letter may be displayed in a different color, underlined, bold, italic, or in some other manner to indicate to the user that selecting this candidate word will change a letter entered by the user.

The method then continues to block 330 where a user selection from the displayed modified candidate word list is received by the system. In some embodiments, receiving a user selection may comprise automatically selecting the first word in the candidate list based on a pre-determined user input such as a space character or completion gesture. Alternatively or additionally, receiving a user selection may comprise tapping on a word in the displayed modified candidate list or using a pointing device, arrow keys, or joystick, or the user selection may comprise a space, punctuation mark, or end gesture, without completing the word entry, signifying a selection of the first candidate word or a most probable candidate word. The method then continues to block 335 where the selected candidate word is added to the previously-entered text. Adding the selected word may comprise replacing or augmenting one or more characters previously displayed that correspond to the user input (A).

For example, on a conventional 12-keypad used for Chinese input, if the prior n-gram (or previously-entered user input) is [symbol] (show/program) at block 310, and the user then taps keys corresponding to 426526, then conventionally the top four candidates would be [symbol] (a Chinese college entrance examination); [symbol] (good-looking/interesting); [symbol] (olives); and [symbol] (speak highly of). In method 300, however, based on the received n-gram and user-entered keystrokes, then the retrieved words at block 315 would be [symbol] (interesting), [symbol] (poor); [symbol] (Chinese college entrance exam); and [symbol] (olives). The system selected “show is interesting” and “show is poor” as first and second candidates for the candidate word list, respectively, because these next words exist in the language model and have the highest probability of being the “next word”. If no candidate next words exist or no additional candidate next words exist in the language model, then the system chooses candidates based solely on frequency (and not based on n-gram), such as college entrance exam and olive, which would be third and fourth candidates.

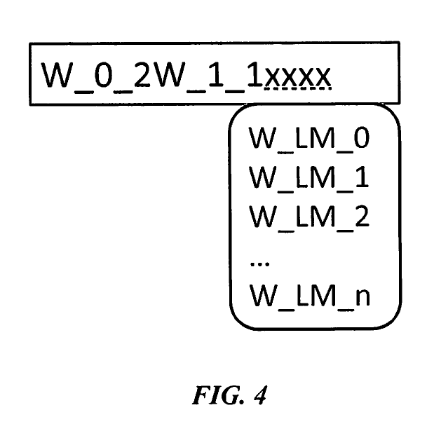

FIG. 4 is a diagram conceptually illustrating a display that a user might see when providing input and receiving output according to the method 300. The system receives confirmed user input A comprising at least two Chinese words, in this example, two Chinese words, W_0_2 and W_1_1. In other words, the two Chinese words are the prior n-gram provided by the user. The user then inputs into the system Chinese characters via a phonetic system (in transcription, e.g., pinyin, BPMF, etc.). In FIG. 4, the phonetic entry is represented by the characters “xxxx.” Based on the received phonetic entry (“xxxx”) and the prior n-gram (“W_0_2 and W_1_1”), the system outputs a list of potential next character candidates for consideration by the user. In FIG. 4, the output is represented by the list of W_LM_0, W_LM_1, W_LM_n. In some embodiments, the presented list of next character candidates by ranked by conditional probability. That is, using n-grams W_0_2 and W_1_1 (p(w|W_0_2, W_1_1)) from language model (LM), candidates (w) will be sorted in accordance with their probability p(w|W_0_2, W_1_1) from highest to lowest.

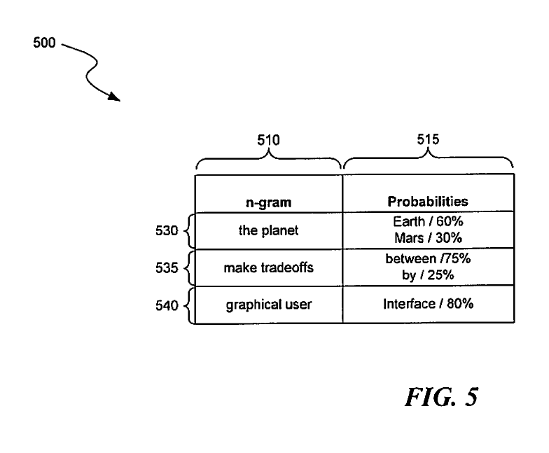

FIG. 5 is a block diagram illustrating an example of a data structure 500 containing conditional probabilities for particular n-grams. The database 172 may include data as structured in the data structure 500. Column 510 includes n-grams (where n=2) while column 515 includes next word candidates and, optionally, their probabilities. In order to reduce memory and speed processing, next word candidates with a probability of less than 25% may not be listed. For example, in row 540, n-gram “graphical user” has a next word candidate of “interface” with 80%. If no other next word candidates that exceed 25% exist, no other candidates are listed in column 515 for row 540.

As noted before, n is not limited to 2 but could be 3 or more. Further, the database 172 could store n-grams for multiple values of n. In addition, the database could store language models for multiple languages and/or contexts (e.g., contexts based on a location and application type being used to enter text).

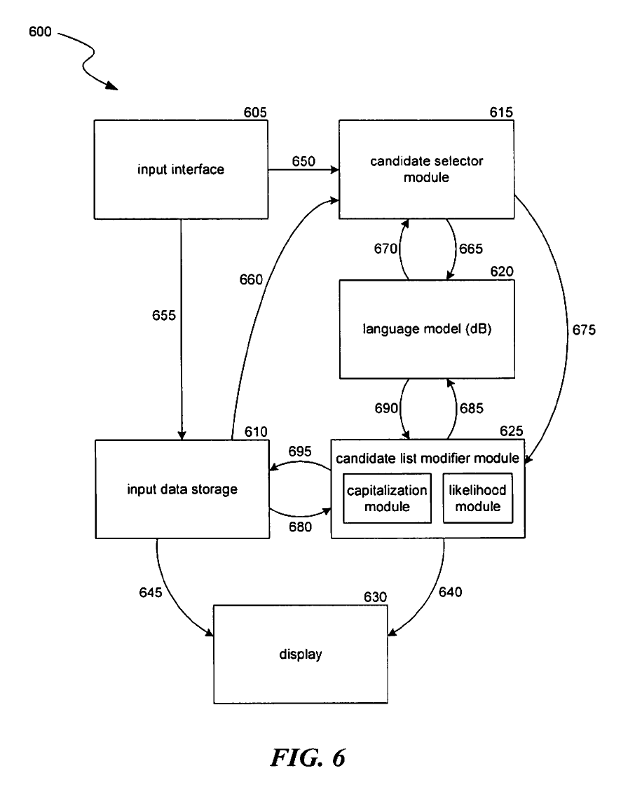

FIG. 6 is a block diagram illustrating a system 600 for entering text for a computing device. The system comprises input interface 605, input data storage 610, candidate selector module 615, language model 620, candidate list modifier module 625, and display 630.

The input interface 605 receives a user input (S) indicating one or more characters of a word or the Romanization of a Chinese word (e.g., pinyin) or a word in another language. The actual user input (S), or a translation of the user input (S) into the corresponding characters, may be passed 655 to the input data storage 610 which adds them to an input structure. The input characters may be passed 645 to the display 630, which may display the characters.

Candidate selector module 615 may receive 650 the user input (S) and may also receive 660 a prior n-gram from the input data storage 610. The candidate selector module 615 may then select one or more candidate words based on the user input (S). Candidate selector module 615 may generate a request such as a database query to select matching words. The request may be sent 665 to the language model 620, which is formatted or stored as described above. Language model 620 may be local (associated with the computing system having the input interface or display) or remote (accessible via one or more function or service calls), and may be implemented as a database or other data structure. In some embodiments, the request for candidate words may also be based on the determined context. Language model 620 passes 670 candidate words back to the candidate selector module 615. The candidate selector module passes 675 the candidate list to the candidate list modifier module 625. In an implementation, the candidate selector module 615 may also update probabilities in the language model 620 based on frequency of user selections of candidate words.

Candidate list modifier module 625 receives 675 the candidate list and also receives 680 a prior n-gram, wherein n≧2. The candidate list modifier module generates a request for conditional probabilities for the words in the candidate list given the prior n-gram and sends 685 the request to the language model 620. Language model 620, returns 690 to the candidate list modifier module 625 a set of conditional probabilities for the words in the candidate list given the prior n-gram. Candidate list modifier module 625 then may use the capitalization module to capitalize words in the candidate list that have a conditional probability of being capitalized that is above a predetermined threshold. Candidate list modifier module 625 also uses the likelihood module to order words in the candidate list according to values assigned to the words corresponding to conditional probabilities or default values. The candidate list modifier module 625 may also receive the user input (S) and place the corresponding characters as the first item in the modified candidate word list. The candidate list modifier module 625, passes 640 the modified list of candidate words to the display 630. A user may enter another user input (T) via the user interface 605, selecting a word from the modified candidate word list. User input (T) may cause the selected word to be entered 695 in the input data storage in place of, or by modifying, the input originally received 655 by the input data storage.

### CONCLUSION

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/we claim:

1. A method to facilitate the user entry of text on a computing system, the method comprising:
receiving, on the computing system, an n-gram comprising multiple words from a user, wherein n≧2;
receiving, on the computing system, a user input corresponding to at least part of a word following the received n-gram;
retrieving from a language model, based on the received n-gram and the user input, candidate words to follow the n-gram, the candidate words determined based on conditional probabilities that the candidate words will follow the received n-gram;
displaying the retrieved candidate words;
receiving a user selection from the displayed candidate words; and
using the user-selected word to replace or supplement the user input.

2. The method of claim 1, wherein the conditional probability is an estimate of the likelihood that a user intended the word given the received n-gram.

3. The method of claim 2, further comprising updating probabilities in the language model based on the user selection of candidate words.

4. The method of claim 3, wherein the probabilities are increased or decreased based on the frequency of user selection of candidate words.

5. The method of claim 1, further comprising:
determining a context in which the n-gram is received from the user; and
using the determined context to further determine the retrieved candidate words from the language model to follow the n-gram.

6. The method of claim 5, wherein the context includes an application associated with the entered text on the computing system.

7. The method of claim 5, wherein the context includes a location of the computing system.

8. The method of claim 1, wherein the retrieved candidate words are displayed to a user with the highest probability candidate words displayed first.

9. A computer-readable storage medium storing instructions that, when executed by a computing device, cause the computing device to perform operations to facilitate the entry of text on the computing device by a user, the operations comprising:
receiving, on the computing device, an n-gram comprising multiple words from a user, wherein n≧2;
receiving, on the computing device, a user input corresponding to at least part of a word following the received n-gram;
retrieving from a language model, based on the received n-gram and the user input, candidate words to follow the n-gram, the candidate words determined based on conditional probabilities that the candidate words will follow the received n-gram;
displaying the retrieved candidate words;
receiving a user-selection from the displayed candidate words; and
using the user-selected word to replace or supplement the user input.

10. The computer-readable storage medium of claim 9, further comprising instructions that, when executed by a computing device, cause the computing device to perform operations comprising:
determining a context in which the n-gram is received from the user; and
using the determined context to further determine the retrieved candidate words from the language model to follow the n-gram.

11. The computer-readable storage medium of claim 11, wherein the context includes an application associated with the entered text on the computing device or a location of the computing device.

12. A system, comprising:
an input data storage configured to store an n-gram comprising multiple words, where n≧2, the n-gram previously received from a user, and a user input corresponding to at least part of a word entered by the user following the previous n-gram;
a candidate selector module configured to retrieve from a language model, based on the stored n-gram and the user input, candidate words to follow the n-gram, the candidate words determined based on conditional probabilities that the candidate words will follow the received n-gram;
a display configured to display the retrieved candidate words;
an input interface is configured to receive a user selection indicating a word from the displayed candidate words; and
wherein the input data storage is further configured to receive and store the selected candidate word.

13. The system of claim 12, wherein the conditional probability is an estimate of the likelihood that a user intended the word given the received n-gram.

14. The system of claim 13, wherein the candidate selector module is further configured to update probabilities in the language module based on the user selection of candidate words.

15. The system of claim 14, wherein the candidate selector module updates the probabilities based on the frequency of user selection of candidate words.

16. The system of claim 12, wherein the candidate selector module is further configured to:
determine a context in which the n-gram is received from the user; and
use the determined context to further determine the retrieved candidate words from the language model to follow the n-gram.

17. The system of claim 16, wherein the context includes an application associated with the entered text.

18. The system of claim 16, wherein the context includes a location of the system.
